(19) United States
(12) Patent Application Publication
(10) Pub. No.: US 2025/0130935 A1
(43) Pub. Date: Apr. 24, 2025

(54) DEVICE CONTROL METHOD, MEMORY STORAGE DEVICE AND MEMORY CONTROL CIRCUIT UNIT

(71) Applicant: PHISON ELECTRONICS CORP., Miaoli (TW)

(72) Inventors: Yuwei Kuo, Hsinchu City (TW); Hung Yuan Tsai, Hsinchu County (TW); Chun Ming Liu, Taipei City (TW); Yu Hsuan Chen, New Taipei City (TW); Yun-You Lin, Kaohsiung City (TW)

(73) Assignee: PHISON ELECTRONICS CORP., Miaoli (TW)

(21) Appl. No.: 18/522,148

(22) Filed: Nov. 28, 2023

(30) Foreign Application Priority Data
Oct. 24, 2023 (TW) 112140650

(51) Int. Cl. G06F 12/02

(52) U.S. Cl. CPC G06F 12/023

(57) ABSTRACT

A device control method, a memory storage device, and a memory control circuit unit are disclosed. The method includes: establishing a connection between the memory storage device and a host system; performing a first communication with the host system based on the connection and a first connection interface standard; performing a data recovery operation between the memory storage device and the host system via the connection during a period of performing the first communication; and switching to perform a second communication with the host system based on the connection and a second connection interface standard in a case that the data recovery operation is successfully performed, wherein the first connection interface standard is different from the second connection interface standard.

### CROSS-REFERENCE TO RELATED APPLICATION

This application claims the priority benefit of Taiwan application serial no. 112140650, filed on Oct. 24, 2023. The entirety of the above-mentioned patent application is hereby incorporated by reference herein and made a part of this specification.

### BACKGROUND OF THE INVENTION

### Field of the Invention

The invention relates to a device control technique, and more particularly, to a device control method, a memory storage device, and a memory control circuit unit.

### Description of Related Art

Portable electronic devices such as mobile phones and notebook computers have grown rapidly in the past few years, which has led to a rapid increase in consumer demand for storage media. Since a rewritable non-volatile memory module (such as a flash memory) has characteristics such as data non-volatility, power-saving, small size, and lack of mechanical structures, the rewritable non-volatile memory module is very suitable to be built into the various portable electronic devices provided above.

With the advancement of technology, users have gradually increased demands on the data transfer speed between the memory storage device and the host system. Taking the Peripheral Component Interconnect Express (PCI Express) standard as an example, from the first generation (Gen 1) to the fifth generation (Gen 5) of the PCI Express standard, the supported data transfer speed has increased significantly. However, as the data transfer speed between the memory storage device and the host system is increased, adverse effects on the memory storage device and the host system include increased energy consumption (such as temperature and/or power consumption) of the device. Moreover, under poor signal transfer conditions, the communication performance between the memory storage device and the host system also may not be significantly improved even if operated on the fifth generation of the high-speed peripheral component interconnect express standard. Therefore, how to dynamically adjust the connection interface standard adopted according to the current signal transfer conditions to achieve a good balance between the energy consumption, performance, and operational stability of the memory storage device is actually one of the topics studied by researchers in related technical fields.

### SUMMARY OF THE INVENTION

The invention provides a device control method, a memory storage device, and a memory control circuit unit that may achieve a good balance between energy consumption, performance, and operational stability of the memory storage device.

An exemplary embodiment of the invention provides a device control method for a memory storage device. The device control method includes: establishing a connection between the memory storage device and a host system; performing a first communication with the host system based on the connection and a first connection interface standard; performing a data recovery operation between the memory storage device and the host system via the connection during a period of performing the first communication; and switching to perform a second communication with the host system based on the connection and a second connection interface standard in a case that the data recovery operation is successfully performed, wherein the first connection interface standard is different from the second connection interface standard.

An exemplary embodiment of the invention further provides a memory storage device, including a connection interface unit, a rewritable non-volatile memory module, and a memory control circuit unit. The connection interface unit is configured to be coupled to a host system. The memory control circuit unit is coupled to the connection interface unit and the rewritable non-volatile memory module. The memory control circuit unit is configured to: establish a connection between the memory storage device and the host system; perform a first communication with the host system based on the connection and a first connection interface standard; perform a data recovery operation between the memory storage device and the host system via the connection during a period of performing the first communication; and switch to perform a second communication with the host system based on the connection and a second connection interface standard in a case that the data recovery operation is successfully performed, wherein the first connection interface standard is different from the second connection interface standard.

An exemplary embodiment of the invention further provides a memory control circuit unit configured to control a rewritable non-volatile memory module in the memory storage device. The memory control circuit unit includes a host interface, a memory interface, and a memory management circuit. The host interface is configured to be coupled to a host system. The memory interface is configured to be coupled to the rewritable non-volatile memory module. The memory management circuit is coupled to the host interface and the memory interface. The memory management circuit is configured to: establish a connection between the memory storage device and the host system; perform a first communication with the host system based on the connection and a first connection interface standard; perform a data recovery operation between the memory storage device and the host system via the connection during a period of performing the first communication; and switch to perform a second communication with the host system based on the connection and a second connection interface standard in a case that the data recovery operation is successfully performed, wherein the first connection interface standard is different from the second connection interface standard.

Based on the above, after the connection between the memory storage device and the host system is established, the memory storage device may perform the first communication with the host system based on the connection and the first connection interface standard. During the period of performing the first communication, the memory storage device may perform the data recovery operation between the memory storage device and the host system via the connection. Thereafter, in a case that the data recovery operation is successful, the memory storage device may switch to perform the second communication with the host system based on the connection and the second connection interface standard. The first connection interface standard is different from the second connection interface standard. In this way, a good balance may be achieved between the energy consumption, performance, and operational stability of the memory storage device.

### BRIEF DESCRIPTION OF THE DRAWINGS

FIG. 1 is a schematic diagram of a host system, a memory storage device, and an input/output (I/O) device shown according to an exemplary embodiment of the invention.

FIG. 2 is a schematic diagram of a host system, a memory storage device, and an I/O device shown according to an exemplary embodiment of the invention.

FIG. 3 is a schematic of a host system and a memory storage device shown according to an exemplary embodiment of the invention.

FIG. 4 is a schematic block diagram of a memory storage device shown according to an exemplary embodiment of the invention.

FIG. 5 is a schematic block diagram of a memory control circuit unit shown according to an exemplary embodiment of the disclosure.

FIG. 6 is a schematic diagram of the management of a rewritable non-volatile memory module shown according to an exemplary embodiment of the invention.

FIG. 7 is a schematic diagram of various connection interface standards shown according to an exemplary embodiment of the invention.

FIG. 8 is an operational sequence diagram of the interaction between a memory storage device and a host system shown according to an exemplary embodiment of the invention.

FIG. 9 is a schematic eye diagram of a first signal shown according to an exemplary embodiment of the invention.

FIG. 10 is a schematic operational sequence diagram of a data recovery operation shown according to an exemplary embodiment of the invention.

FIG. 11 is an operational sequence diagram of the interaction between a memory storage device and a host system shown according to an exemplary embodiment of the invention.

### DESCRIPTION OF THE EMBODIMENTS

In general, a memory storage device (also referred to as a memory storage system) includes a rewritable non-volatile memory module and a controller (also referred to as a control circuit). The memory storage device may be used with a host system, such that the host system may write data into the memory storage device or read data from the memory storage device.

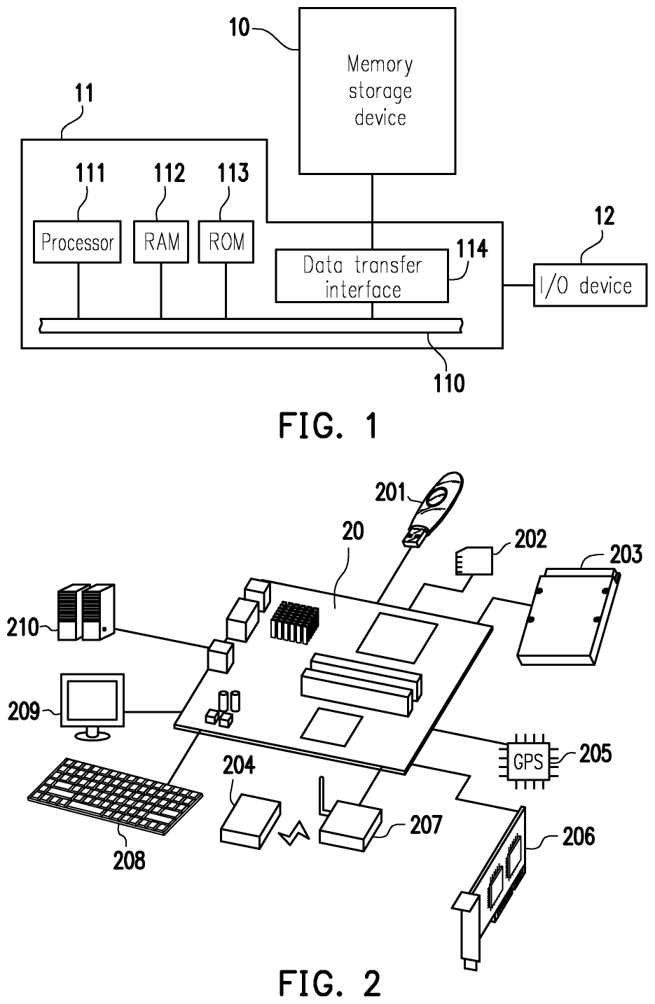

FIG. 1 is a schematic diagram of a host system, a memory storage device, and an input/output (I/O) device shown according to an exemplary embodiment of the invention. FIG. 2 is a schematic diagram of a host system, a memory storage device, and an I/O device shown according to an exemplary embodiment of the invention.

Referring to FIG. 1 and FIG. 2, a host system 11 may include a processor 111, a random-access memory (RAM) 112, a read-only memory (ROM) 113, and a data transfer interface 114. The processor 111, the RAM 112, the ROM 113, and the data transfer interface 114 may be coupled to a system bus 110.

In an exemplary embodiment, the host system 11 may be coupled to a memory storage device 10 via the data transfer interface 114. For example, the host system 11 may store data into the memory storage device 10 or read data from the memory storage device 10 via the data transfer interface 114. Moreover, the host system 11 may be coupled to the I/O device 12 via the system bus 110. For example, the host system 11 may send an output signal to the I/O device 12 or receive an input signal from the I/O device 12 via the system bus 110.

In an exemplary embodiment, the processor 111, the RAM 112, the ROM 113, and the data transfer interface 114 may be disposed on a motherboard 20 of the host system 11. The quantity of the data transfer interface 114 may be one or a plurality. The motherboard 20 may be coupled to the memory storage device 10 in a wired or wireless method via the data transfer interface 114.

In an exemplary embodiment, the memory storage device 10 may be, for example, a flash drive 201, a memory card 202, a solid-state drive (SSD) 203, or a wireless memory storage device 204. The wireless memory storage device 204 may be, for example, a memory storage device based on various wireless communication techniques such as a near-field communication (NFC) memory storage device, a wireless fax (WiFi) memory storage device, a Bluetooth memory storage device, or a low-power Bluetooth memory storage device (such as iBeacon). Moreover, the motherboard 20 may also be coupled to various I/O devices such as a global positioning system (GPS) module 205, a network interface card 206, a wireless transfer device 207, a keyboard 208, a screen 209, or a speaker 210 via the system bus 110. For example, in an exemplary embodiment, the motherboard 20 may access the wireless memory storage device 204 via the wireless transfer device 207.

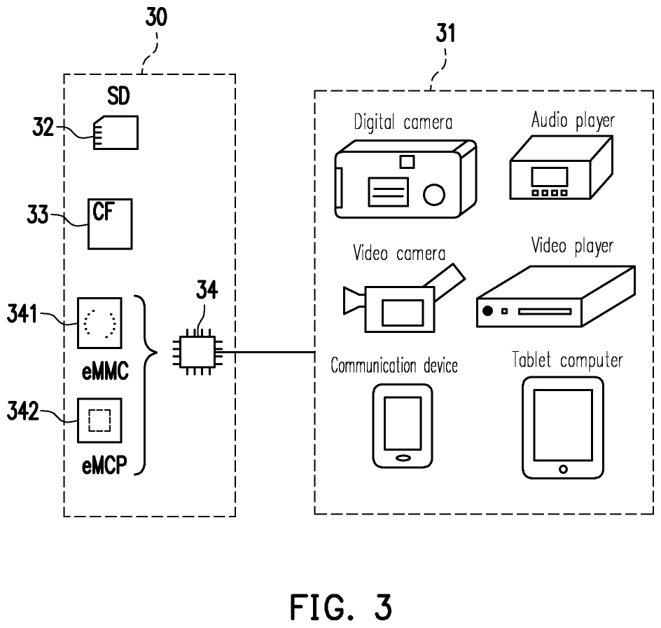

In an exemplary embodiment, the host system 11 is a computer system. In an exemplary embodiment, the host system 11 may be any system that may substantially store data with the memory storage device. In an exemplary embodiment, the memory storage device 10 and the host system 11 may respectively include a memory storage device 30 and a host system 31 of FIG. 3.

FIG. 3 is a schematic of a host system and a memory storage device shown according to an exemplary embodiment of the invention. Referring to FIG. 3, the memory storage device 30 may be used in conjunction with the host system 31 to store data. For example, the host system 31 may be a digital camera, a video camera, a communication device, an audio player, a video player, or a tablet computer. For example, the memory storage device 30 may be various non-volatile memory storage devices such as a secure digital (SD) card 32, a compact flash (CF) card 33, or an embedded storage device 34 used by the host system 31. The embedded storage device 34 includes various types of embedded storage devices that directly couple a memory module to a substrate of the host system such as an embedded multimedia card (eMMC) 341 and/or an embedded multi-chip package (eMCP) storage device 342.

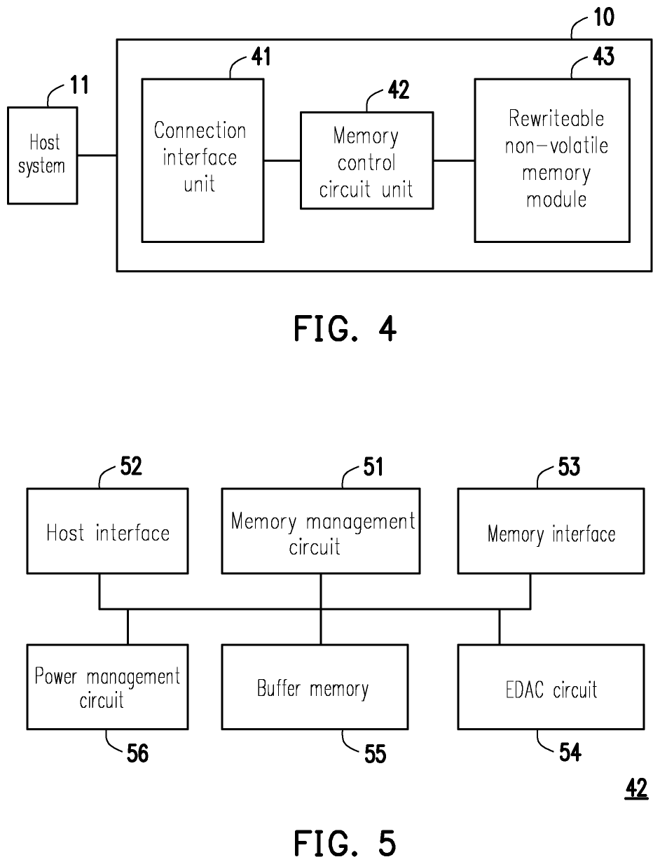

FIG. 4 is a schematic diagram of a memory storage device shown according to an exemplary embodiment of the invention. Referring to FIG. 4, the memory storage device 10 includes a connection interface unit 41, a memory control circuit unit 42, and a rewritable non-volatile memory module 43.

The connection interface unit 41 is configured to be coupled to the host system 11. The memory storage device 10 may be communicated with the host system 11 via the connection interface unit 41. In an exemplary embodiment, the connection interface unit 41 is compatible with the Peripheral Component Interconnect Express (PCI Express) standard. In an exemplary embodiment, the connection interface unit 41 may also conform to Serial Advanced Technology Attachment (SATA) standard, Parallel Advanced Technology Attachment (PATA) standard, Institute of Electrical and Electronic Engineers (IEEE) 1394 standard, Universal Serial Bus (USB) standard, SD interface standard, Ultra High Speed-I (UHS-I) interface standard, Ultra High Speed-II (UHS-II) interface standard, Memory Stick (MS) interface standard, MCP interface standard, MMC interface standard, eMMC interface standard, Universal Flash Storage (UFS) interface standard, eMCP interface standard, CF interface standard, Integrated Device Electronics (IDE) standard, or other suitable standards. The connection interface unit 41 may be sealed in a chip with the memory control circuit unit 42. Alternatively, the connection interface unit 41 is disposed outside of a chip containing the memory control circuit unit 42.

The memory control circuit unit 42 is coupled to the connection interface unit 41 and the rewritable non-volatile memory module 43. The memory control circuit unit 42 is configured to perform a plurality of logic gates or control commands implemented in a hardware form or in a firmware form. The memory control circuit unit 404 also performs an operation such as writing, reading, and erasing data in the rewritable non-volatile memory storage module 43 according to the commands of the host system 11.

The rewritable non-volatile memory module 43 is configured to store the data written by the host system 11. The rewritable non-volatile memory module 43 may include a single-level cell (SLC) NAND-type flash memory module (that is, a flash memory module that may store 1 bit in one memory cell), a multi-level cell (MLC) NAND-type flash memory module (that is, a flash memory module that may store 2 bits in one memory cell), a triple-level cell (TLC) NAND-type flash memory module (i.e., a flash memory module that may store 3 bits in one memory cell), a quad-level cell (QLC) NAND-type flash memory module (that is, a flash memory module that may store 4 bits in one memory cell), other flash memory modules, or other memory modules with the same characteristics.

Each of the memory cells in the rewritable non-volatile memory module 43 stores one or a plurality of bits via the change in voltage (also referred to as threshold voltage hereinafter). Specifically, a charge-trapping layer is disposed between the control gate and the channel of each of the memory cells. By applying a write voltage to the control gate, the number of electrons of the charge-trapping layer may be changed, and therefore the threshold voltage of the memory cells may be changed. This operation of changing the threshold voltage of the memory cells is also referred to as “writing data to the memory cells” or “programming the memory cells”. As the threshold voltage is changed, each of the memory cells in the rewritable non-volatile memory module 43 has a plurality of storage states. Which storage state one memory cell belongs to may be determined via the application of a read voltage, so as to obtain one or a plurality of bits stored by the memory cell.

In an exemplary embodiment, the memory cells of the rewritable non-volatile memory module 43 may form a plurality of physical programming units, and the physical programming units may form a plurality of physical erasing units. Specifically, the memory cells on the same word line may form one or a plurality of physical programming units. If each of the memory cells may store 2 or more bits, the physical programming units on the same word line may be at least classified into lower physical programming units and upper physical programming units. For example, the least significant bit (LSB) of a memory cell belongs to the lower physical programming units, and the most significant bit (MSB) of a memory cell belongs to the upper physical programming units. Generally, in an MLC NAND-type flash memory, the write speed of the lower physical programming units is greater than the write speed of the upper physical programming units, and/or the reliability of the lower physical programming units is greater than the reliability of the upper physical programming units.

In an exemplary embodiment, the physical programming unit is the smallest unit of programming. That is, the physical programming unit is the smallest unit of data writing. For example, the physical programming unit may be a physical page or a physical sector. In a case that the physical programming unit is a physical page, the physical programming units may include a data bit area and a redundancy bit area. The data bit area contains a plurality of physical sectors configured to store user data, and the redundancy bit area is configured to store system data (for example, management data such as an ECC). In an exemplary embodiment, the data bit area includes 32 physical sectors, and the size of one physical sector is 512 bytes (B). However, in other exemplary embodiments, the data bit area may also contain 8, 16, or a greater or lesser number of physical sectors, and the size of each of the physical sectors may also be greater or less. Moreover, the physical erasing unit is the smallest unit of erasing. That is, each of the physical erasing units contains the smallest number of memory cells erased together. For example, the physical erasing units are physical blocks.

FIG. 5 is a schematic diagram of a memory control circuit unit shown according to an exemplary embodiment of the invention. Referring to FIG. 5, the memory control circuit unit 42 includes a memory management circuit 51, a host interface 52, and a memory interface 53.

The memory management circuit 51 is configured to control the overall operation of the memory control circuit unit 42. Specifically, the memory management circuit 51 has a plurality of control commands. During the operation of the memory storage device 10, the control commands are executed to perform an operation such as writing, reading, and erasing data. In the following, descriptions relating to the operation of the memory management circuit 51 are equivalent to the descriptions of the operation of the memory control circuit unit 42 and the memory storage device 10.

In an exemplary embodiment, the control commands of the memory management circuit 51 are implemented in a firmware form. For example, the memory management circuit 51 has a microprocessor unit (not shown) and a read-only memory (not shown), and the control commands are burned into the ROM. During the operation of the memory storage device 10, the control commands are executed by the microprocessor unit to perform an operation such as writing, reading, and erasing data.

In an exemplary embodiment, the control commands of the memory management circuit 51 may also be stored in a specific area of the rewritable non-volatile memory module 43 (for example, a system area dedicated to storing system data in the memory module) in the form of program codes. Moreover, the memory management circuit 51 has a microprocessor unit (not shown), an ROM (not shown), and a RAM (not shown). In particular, the ROM has a boot code, and when the memory control circuit unit 42 is enabled, the microprocessor unit first executes the boot code to load the control commands stored in the rewritable non-volatile memory module 43 into the RAM of the memory management circuit 51. Next, the microprocessor unit runs the control commands to perform an operation such as writing, reading, and erasing data.

In an exemplary embodiment, the control commands of the memory management circuit 51 may also be implemented in a hardware form. For example, the memory management circuit 51 includes a microcontroller, a memory cell management circuit, a memory write circuit, a memory read circuit, a memory erase circuit, and a data processing circuit. The memory cell management circuit, the memory write circuit, the memory read circuit, the memory erase circuit, and the data processing circuit are coupled to the microcontroller. The memory cell management circuit is configured to manage memory cells or memory cell groups of the rewritable non-volatile memory module 43. The memory write circuit is configured to issue a write command sequence to the rewritable non-volatile memory module 43 to write data into the rewritable non-volatile memory module 43. The memory read circuit is configured to issue a read command sequence to the rewritable non-volatile memory module 43 to read data from the rewritable non-volatile memory module 43. The memory erase circuit is configured to issue an erase command sequence to the rewritable non-volatile memory module 43 to erase data from the rewritable non-volatile memory module 43. The data processing circuit is configured to process the data to be written into the rewritable non-volatile memory module 43 and the data read from the rewritable non-volatile memory module 43. The write command sequence, the read command sequence, and the erase command sequence may independently include one or a plurality of program codes or command codes and be configured to instruct the rewritable non-volatile memory module 43 to perform a corresponding operation such as writing, reading, and erasing. In an exemplary embodiment, the memory management circuit 51 may also issue other types of command sequences to the rewritable non-volatile memory module 43 to instruct the performance of a corresponding operation.

The host interface 52 is coupled to the memory management circuit 51. The memory management circuit 51 may be communicated with the host system 11 via the host interface 52. The host interface 52 may be configured to receive and identify a command and data sent by the host system 11. For example, the command and data sent by the host system 11 may be sent to the memory management circuit 51 via the host interface 52. In addition, the memory management circuit 51 may send data to the host system 11 via the host interface 52. In the present exemplary embodiment, the host interface 52 is compatible with the PCI Express standard. However, it should be understood that the invention is not limited thereto, and the host interface 52 may also be compatible with the SATA standard, PATA standard, IEEE 1394 standard, USB standard, SD standard, UHS-I standard, UHS-II standard, MS standard, MMC standard, eMMC standard, UFS standard, CF standard, IDE standard, or other suitable standards for data transfer.

The memory interface 53 is coupled to the memory management circuit 51 and configured to access the rewritable non-volatile memory module 43. For example, the memory management circuit 51 may access the rewritable non-volatile memory module 43 via the memory interface 53. That is, the data to be written into the rewritable non-volatile memory module 43 is converted into a format acceptable to the rewritable non-volatile memory module 43 via the memory interface 53. Specifically, if the memory management circuit 51 is to access the rewritable non-volatile memory module 43, the memory interface 53 sends the corresponding command sequence. For example, the command sequence may include a write command sequence instructing data writing, a read command sequence instructing data reading, an erase command sequence instructing data erasing, and a corresponding command sequence configured to instruct various memory operations (such as changing read voltage level or performing a garbage collection (GC) operation). The command sequence is generated by, for example, the memory management circuit 51 and sent to the rewritable non-volatile memory module 43 via the memory interface 53. The command sequence may include one or a plurality of signals or data on a bus. The signals or data may include command codes or program codes. For example, when reading a command sequence, information such as read identification code or memory address is included.

In an exemplary embodiment, the memory control circuit unit 42 further includes an error detection and correction circuit 54, a buffer memory 55, and a power management circuit 56.

The error detection and correction circuit 54 is coupled to the memory management circuit 51 and configured to execute an error detection and correction operation to ensure the correctness of data. Specifically, when the memory management circuit 51 receives a write command from the host system 11, the error detection and correction circuit 54 generates a corresponding error correcting code (ECC) and/or error detecting code (EDC) for the data corresponding to the write command, and the memory management circuit 51 writes the data corresponding to the write command and the corresponding ECC and/or EDC into the rewritable non-volatile memory module 43. Next, when data is read from the rewritable non-volatile memory module 43, the memory management circuit 51 reads the ECC and/or the EDC corresponding to the data at the same time, and the error detection and correction circuit 54 executes an error detection and correction operation on the read data based on the ECC and/or the EDC.

The buffer memory 55 is coupled to the memory management circuit 51 and configured to temporarily store data. The power management circuit 56 is coupled to the memory management circuit 51 and configured to control the power of the memory storage device 10.

In an exemplary embodiment, the rewritable non-volatile memory module 43 of FIG. 4 may include a flash memory module. In an exemplary embodiment, the memory control circuit unit 42 of FIG. 4 may include a flash memory controller. In an exemplary embodiment, the memory management circuit 51 of FIG. 5 may include a flash memory management circuit.

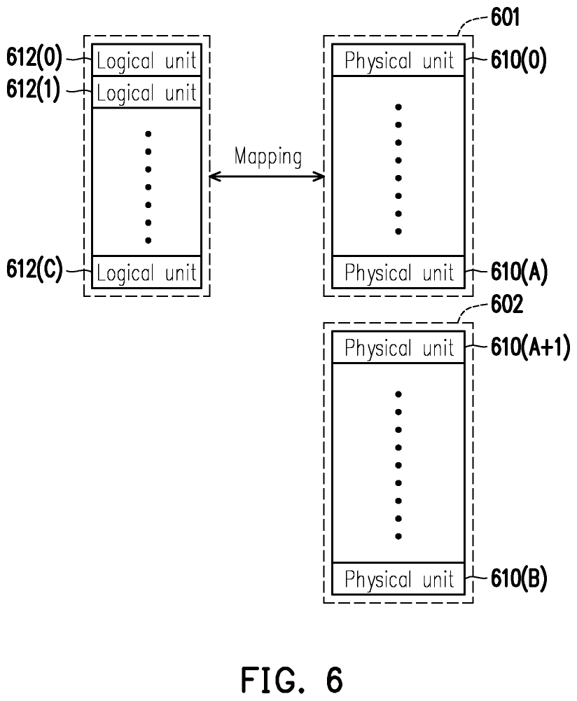

FIG. 6 is a schematic diagram of the management of a rewritable non-volatile memory module shown according to an exemplary embodiment of the invention. Referring to FIG. 6, the memory management circuit 51 may logically group physical units 610(0) to 610(B) in the rewritable non-volatile memory module 43 into a storage area 601 and a spare area 602.

In an exemplary embodiment, one physical unit refers to one physical address or one physical programming unit. In an exemplary embodiment, one physical unit may also be formed by a plurality of continuous or discontinuous physical addresses. In an exemplary embodiment, one physical unit may also refer to one virtual block (VB). One virtual block may include a plurality of physical addresses or a plurality of physical programming units. In an exemplary embodiment, one virtual block may include one or a plurality of physical erasing units.

In an exemplary embodiment, the physical units 610(0) to 610(A) in the storage area 601 are configured to store user data (for example, user data from the host system 11 in FIG. 1). For example, the physical units 610(0) to 610(A) in the storage area 601 may store valid data and invalid data. The physical units 610(A+1) to 610(B) in the spare area 602 do not store data (e.g., valid data). For example, in a case that a certain physical unit does not store valid data, this physical unit may be associated with (or added) to the spare area 602. In addition, the physical units (or physical units that do not store valid data) in the spare area 602 may be erased. When writing new data, one or a plurality of physical units may be extracted from the spare area 602 to store the new data. In an exemplary embodiment, the spare area 602 is also called a free pool.

In an exemplary embodiment, the memory management circuit 51 may configure logical units 612(0) to 612(C) to map the physical units 610(0) to 610(A) in the storage area 601. In an exemplary embodiment, each of the logical units corresponds to one logical address. For example, one logical address may include one or a plurality of logical block addresses (LBAs) or other logical management units. In an exemplary embodiment, one logical unit may also correspond to one logic programming unit or be formed by a plurality of continuous or discontinuous logical addresses.

It should be noted that one logical unit may be mapped to one or a plurality of physical units. If a certain physical unit is currently mapped by a certain logical unit, the data currently stored in the physical unit includes valid data. On the other hand, if a certain physical unit is currently not mapped by any logical unit, the data currently stored in the physical unit is valid data.

In an exemplary embodiment, the memory management circuit 51 may record management data describing the mapping relationship between logical units and physical units (also referred to as logical-to-physical mapping information) in at least one logical-to-physical mapping table. When the host system 11 is to read data from the memory storage device 10 or write data to the memory storage device 10, the memory management circuit 51 may access the rewritable non-volatile memory module 43 according to the information in the logical-to-physical mapping table.

In an exemplary embodiment, the connection interface standard that may be adopted by the connection interface unit 41 may include at least two of first generation (Gen 1), second generation (Gen 2), third generation (Gen 3), fourth generation (Gen 4), and fifth generation (Gen 5) of the PCI Express standard. In an exemplary embodiment, the connection interface unit 41 may also adopt other types of connection interface standards, which are not limited in the invention.

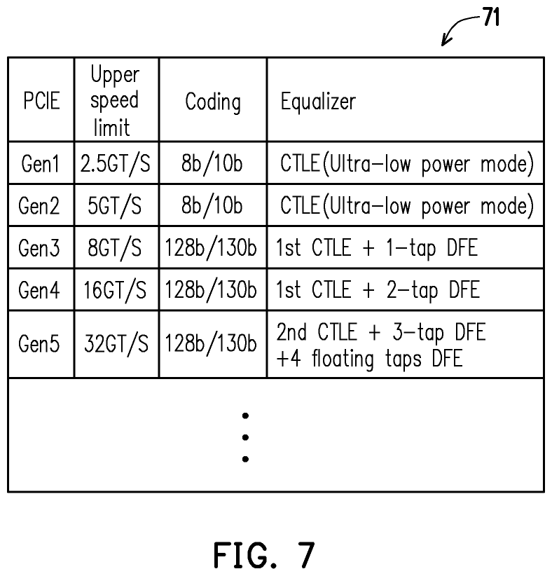

FIG. 7 is a schematic diagram of various connection interface standards shown according to an exemplary embodiment of the invention. Referring to FIG. 7, Table 71 may record the data transfer specifications respectively corresponding to various types of connection interface standards (such as Gen 1 to Gen 5 of the PCI Express standard). For example, the data transfer specifications may describe, define, or qualify, under a specific connection interface standard, information such as the upper limit of the transfer speed between the memory storage device 10 and the host system 11, the encoding rules adopted by the memory storage device 10, and the equalizer settings of the memory storage device 10. For example, under different connection interface standards, the upper limit of the transfer speed, the encoding rules adopted by the memory storage device 10, and/or the equalizer settings of the memory storage device 10 may be the same or different between the memory storage device 10 and the host system 11. It should be noted that each specification information in Table 71 may be adjusted according to practical needs and is not limited by the invention.

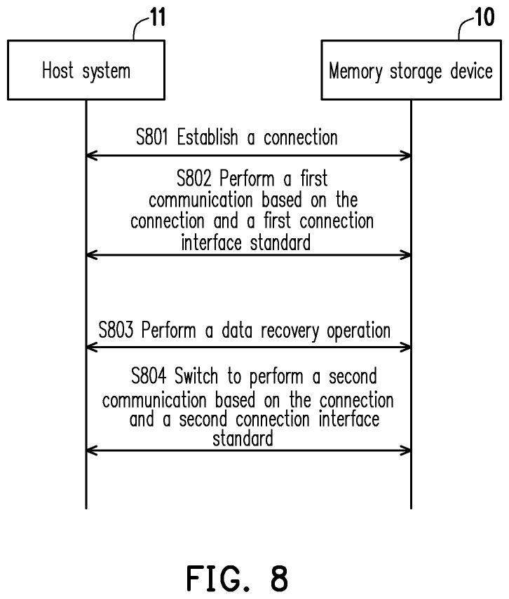

FIG. 8 is an operational sequence diagram of the interaction between a memory storage device and a host system shown according to an exemplary embodiment of the invention. Referring to FIG. 8, in an exemplary embodiment, in step S801, the memory management circuit 51 may establish a connection between the memory storage device 10 and the host system 11. For example, the memory management circuit 51 may instruct the connection interface unit 41 and the host system 11 to perform a handshake operation to establish a connection between the memory storage device 10 and the host system 11. For example, during the handshaking operation, the memory storage device 10 and the host system 11 may exchange signals related to the initialization of the connection such as clock correction.

After the connection between the memory storage device 10 and the host system 11 is established, in step S802, the memory management circuit 51 may perform communication (also called the first communication) between the memory storage device 10 and the host system 11 based on the connection and one connection interface standard (also called the first connection interface standard). For example, in the first communication, the memory management circuit 51 may perform the first communication (e.g., exchange signals) with the host system 11 via the connection interface unit 41 using the first connection interface standard.

In an exemplary embodiment, during the period of performing the first communication, the memory management circuit 51 may receive various operation commands from the host system 11 via the connection interface unit 41 adopting the first connection interface standard and return data to the host system 11 in response to the operation commands. For example, the operation commands may include a read command, a write command, and/or an erase command. The memory management circuit 51 may access the rewritable non-volatile memory module 43 according to the received operation commands. For example, according to the read command from the host system 11, the memory management circuit 51 may instruct the rewritable non-volatile memory module 43 to read data from a specific physical unit and send the read data back to the host system 11. Alternatively, according to a write command from the host system 11, the memory management circuit 51 may instruct the rewritable non-volatile memory module 43 to store data to a specific physical unit. Alternatively, according to an erase command from the host system 11, the memory management circuit 51 may instruct the rewritable non-volatile memory module 43 to erase data stored in a specific physical unit. In an exemplary embodiment, during the period of performing the first communication, the memory management circuit 51 may also actively transmit data or signal to the host system 11 via the connection interface unit 41 adopting the first connection interface standard, which is not limited by the invention.

In step S803, during the period of performing the first communication, the memory management circuit 51 may perform a data recovery operation between the memory storage device 10 and the host system 11 via the connection at least once. This data recovery operation may be configured to restore the reliability of the connection between the memory storage device 10 and the host system 11 and/or the accuracy of identification of the received data by both when the signal transfer quality between the memory storage device 10 and the host system 11 is poor. For example, the data recovery operation may be implemented at the physical layer of the connection interface unit 41.

In step S804, in a case that the data recovery operation is successfully performed, the memory management circuit 51 may switch to perform communication between the memory storage device 10 and the host system 11 (also referred to as the second communication) based on the connection and another connection interface standard (also referred to as the second connection interface standard). For example, in step S804, the memory management circuit 51 may instruct the connection interface unit 41 to switch the adopted connection interface standard from the first connection interface standard to the second connection interface standard. Then, the memory management circuit 51 may perform the second communication with the host system 11 via the connection interface unit 41 using the second connection interface standard. The first connection interface standard is different from the second connection interface standard.

In an exemplary embodiment, the first connection interface standard and the second connection interface standard may be two of Gen 1 to Gen 5 of the PCI Express standard. In an exemplary embodiment, in a case that the first connection interface standard is Gen 5 of the PCI Express standard, the second connection interface standard may be one of Gen 1 to Gen 4 of the PCI Express standard. In an exemplary embodiment, in a case that the first connection interface standard is Gen 4 of the PCI Express standard, the second connection interface standard may be one of Gen 1 to Gen 3 of the PCI Express standard. In an exemplary embodiment, in a case that the first connection interface standard is Gen 3 of the PCI Express standard, the second connection interface standard may be Gen 1 or Gen 2 of the PCI Express standard. In an exemplary embodiment, in a case that the first connection interface standard is Gen 2 of the PCI Express standard, the second connection interface standard may be Gen 1 of the PCI Express standard.

In an exemplary embodiment, the memory management circuit 51 may refer to the information recorded in the Table 71 of FIG. 7 to adjust the connection interface standard adopted by the connection interface unit 41. In an exemplary embodiment, the first connection interface standard and the second connection interface standard may also belong to other types of connection interface standards, as long as the performance meeting the second connection interface standard is less than the performance of the first connection interface standard and/or the power consumption per unit time of the second connection interface standard is less than the power consumption per unit time of the first connection interface standard.

In an exemplary embodiment, during the period of performing the second communication, the memory management circuit 51 may receive various operation commands from the host system 11 via the connection interface unit 41 adopting the second connection interface standard and return data to the host system 11 in response to the operation commands. The relevant operation details are described in detail above, and are not repeated herein. In an exemplary embodiment, during the period of performing the second communication, the memory management circuit 51 may also actively transmit data or signal to the host system 11 via the connection interface unit 41 adopting the second connection interface standard, which is not limited by the invention.

In an exemplary embodiment, during the period of performing the first communication, the memory management circuit 51 may determine whether the signal quality of the first communication is less than a preset condition. In response to the signal quality of the first communication being less than the preset condition, the memory management circuit 51 may perform the data recovery operation. However, in a case that the signal quality of the first communication is not less than the preset condition, the memory management circuit 51 may not perform the data recovery operation.

In an exemplary embodiment, during the period of performing the first communication, the memory management circuit 51 may determine whether at least one error event for the first communication is detected or received. In response to detecting or receiving an error event for the first communication, the memory management circuit 51 may determine that the signal quality of the first communication is less than a preset condition. However, if no error event is detected or received for the first communication, the memory management circuit 51 may determine that the signal quality of the first communication is not less than the preset condition.

In an exemplary embodiment, the frequency with which the memory management circuit 51 detects or receives the error event may be negatively related to the signal quality of the first communication. That is, during the period of performing the first communication, in a case that the memory management circuit 51 detects or receives the error event with a higher frequency, the signal quality of the first communication is worse.

In an exemplary embodiment, the error event includes a signal decoding error for the first communication. For example, during the period of performing the first communication, the memory storage device 10 and the host system 11 may respectively decode signals received via the connection. In an exemplary embodiment, the error event may reflect that the memory storage device 10 and/or the host system 11 may not successfully decode the received signal. Therefore, in an exemplary embodiment, in response to the error event, the memory management circuit 51 may perform the data recovery operation to attempt to restore the reliability of the connection between the memory storage device 10 and the host system 11 and/or the accuracy of identification of received data by both.

In an exemplary embodiment, during the period of performing the first communication, the memory management circuit 51 may update one parameter (also referred to as the first parameter). The first parameter may be configured to reflect the signal quality of the first communication. For example, the value of the first parameter may be positively or negatively related to the signal quality of the first communication. For example, the value of the first parameter is directly related to the signal quality of the first communication. The higher the value of the first parameter, the better the signal quality of the first communication. Alternatively, in a case that the value of the first parameter is negatively related to the signal quality of the first communication, the higher the value of the first parameter, the worse the signal quality of the first communication.

In an exemplary embodiment, during the period of performing the first communication, the memory management circuit 51 may determine whether the first parameter meets a specific condition (also referred to as the first condition). In a case that the data recovery operation is successfully performed, in response to the first parameter meeting the first condition, the memory management circuit 51 may switch to perform the second communication with the host system 11 based on the connection and the second connection interface standard (i.e., perform step S804). However, in a case that the first parameter does not meet the first condition, regardless of whether the data recovery operation is successful, the memory management circuit 51 may continue to perform the first communication (i.e., step S804 is not performed).

In an exemplary embodiment, during the period of performing the first communication, the memory management circuit 51 may update the first parameter according to at least one measurement parameter of the eye diagram of the signal transferred between the memory storage device 10 and the host system 11 (also referred to as the first signal). Thereby, the updated first parameter may reflect the signal quality of the first signal (i.e., the signal quality of the first communication). For example, the measurement parameter may include the eye width and/or eye height of the first signal obtained by analyzing the eye diagram of the first signal.

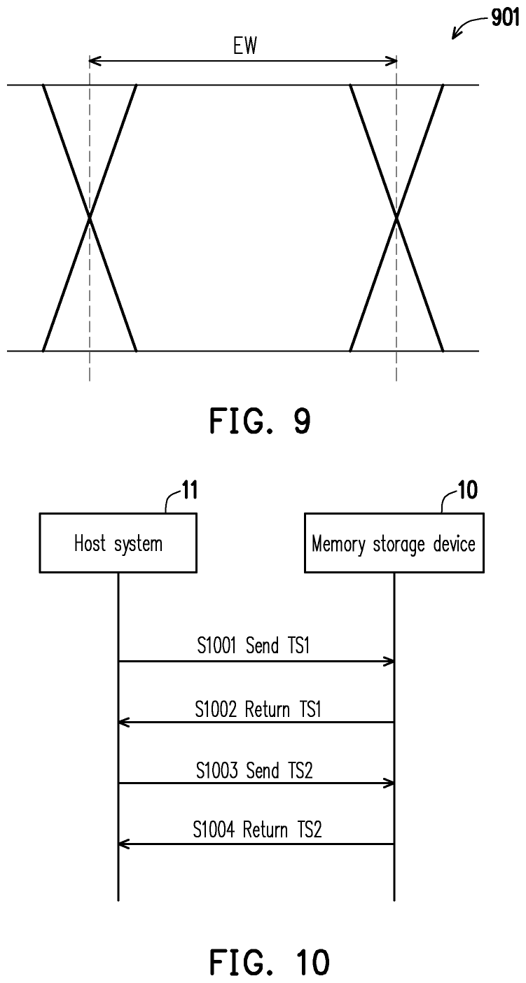

FIG. 9 is a schematic eye diagram of a first signal shown according to an exemplary embodiment of the invention. Referring to FIG. 9, it is assumed that an eye diagram 901 is the eye diagram of the first signal. In an exemplary embodiment, the memory management circuit 51 may analyze the eye diagram 901 via a specific circuit (such as an eye width detector) to obtain an eye width EW of the first signal. The value of the eye width EW may be directly related to the signal quality of the first signal. That is, the greater the value of the eye width EW, the better the signal quality of the first signal. In an exemplary embodiment, the memory management circuit 51 may update the first parameter according to the eye width EW, so that the updated first parameter may reflect the signal quality of the first signal (i.e., the signal quality of the first communication). In an exemplary embodiment, the memory management circuit 51 may also obtain the eye height of the first signal by analyzing the eye diagram 901 and update the first parameter according to the eye height.

In an exemplary embodiment, during the period of performing the first communication, the memory management circuit 51 may update the first parameter according to the proportion of the signal configured to perform signal verification (also referred to as the second signal) among all transfer signals between the memory storage device 10 and the host system 11. Thereby, the updated first parameter may also reflect the signal quality of the first communication. In an exemplary embodiment, the second signal may include one or a plurality of types of signals transferred between the memory storage device 10 and the host system 11 and configured to perform the signal verification during the period of performing the data recovery operation.

In an exemplary embodiment, during the period of performing the first communication, the memory management circuit 51 may evaluate the proportion of the second signal among all transfer signals between the memory storage device 10 and the host system 11. For example, the proportion of the second signal among all transfer signals between the memory storage device 10 and the host system 11 may be negatively related to the signal quality of the first communication. That is, in a case that the proportion of the second signal among all transfer signals between the memory storage device 10 and the host system 11 is higher, during the period of performing the first communication, the data recovery operation between the memory storage device 10 and the host system 11 is performed more frequently, and therefore the signal quality of the first communication is worse. The memory management circuit 51 may update the first parameter according to this proportion. Therefore, in an exemplary embodiment, the updated first parameter may reflect the proportion of the second signal among all transfer signals between the memory storage device 10 and the host system 11.

In an exemplary embodiment, during the period of performing the first communication, the memory management circuit 51 may update the first parameter according to the total number of times that the data recovery operation is performed. For example, the total number of times that the data recovery operation is performed may be negatively related to the signal quality of the first communication. That is, the greater the total number of times that the data recovery operation is performed, the worse the signal quality of the first communication. Thereby, the updated first parameter may also reflect the signal quality of the first communication.

In an exemplary embodiment, during the period of performing the first communication, the memory management circuit 51 may continuously monitor the performance of the data recovery operation. For example, every time n data recovery operations are performed, the memory management circuit 51 may correspondingly update the first parameter (for example, add m to the first parameter), wherein n and m may be any positive integers. Thereby, the updated first parameter may reflect the total number of times that the data recovery operation is performed or the frequency of performance of the data recovery operation during the period of performing the first communication.

FIG. 10 is a schematic operational sequence diagram of a data recovery operation shown according to an exemplary embodiment of the invention. Referring to FIG. 10, in an exemplary embodiment, one data recovery operation may include steps S1001 to S1004. In step S1001, the host system 11 may send a signal TSI to the memory storage device 10. The memory management circuit 51 may receive and identify the signal TS1. In a case that the identification of the signal TS1 is successful, in step S1002, the memory management circuit 51 may return the signal TS1 to the host system 11. After the signal TS1 is received, the host system 11 may verify the signal TS1 from the memory storage device 10. In a case that the verification of the signal TS1 is successful, in step S1003, the host system 11 may send a signal TS2 to the memory storage device 10. After the signal TS2 is received, the memory management circuit 51 may verify the signal TS2. In a case that the verification of the signal TS2 is successful, in step S1004, the memory management circuit 51 may return the signal TS2 to the host system 11. At this point, one data recovery operation may be regarded as completed.

It should be noted that in an exemplary embodiment, the arrow directions of steps S1001 to S1004 may also be reversed, and the invention is not limited thereto. In an exemplary embodiment, the second signal may include the signals TS1 and/or TS2 in FIG. 10. In an exemplary embodiment, the second signal may also include other types of signals used to perform signal verification in the data recovery operation, which is not limited by the invention.

In an exemplary embodiment, the first parameter is negatively related to the signal quality of the first communication. That is, the greater the value of the first parameter, the worse the signal quality of the first communication. Therefore, in an exemplary embodiment, the memory management circuit 51 may determine whether the first parameter is greater than one threshold value (also referred to as the first threshold value). In response to the first parameter being greater than the first threshold value, the memory management circuit 51 may determine that the first parameter meets the first condition. However, in a case that the first parameter is not greater than the first threshold value, the memory management circuit 51 may determine that the first parameter does not meet the first condition.

In an exemplary embodiment, the first parameter is positively related to the signal quality of the first communication. That is, the less the value of the first parameter, the worse the signal quality of the first communication. Therefore, in an exemplary embodiment, the memory management circuit 51 may determine whether the first parameter is less than the first threshold value. In response to the first parameter being less than the first threshold value, the memory management circuit 51 may determine that the first parameter meets the first condition. However, in a case that the first parameter is not less than the first threshold value, the memory management circuit 51 may determine that the first parameter does not meet the first condition. In an exemplary embodiment, the first parameter may also include other types of parameters that may be used to represent the signal quality of the first communication, which is not limited by the invention.

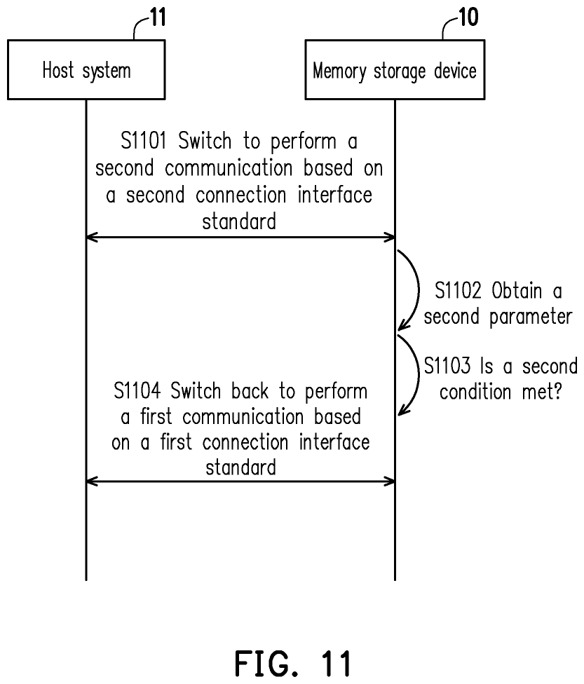

FIG. 11 is an operational sequence diagram of the interaction between a memory storage device and a host system shown according to an exemplary embodiment of the invention. Referring to FIG. 11, in an exemplary embodiment, in step S1101, the memory management circuit 51 switches to perform a second communication with the host system 11 based on the connection and the second connection interface standard.

In step S1102, during the period of performing the second communication, the memory management circuit 51 may update another parameter (also referred to as the second parameter). This second parameter may be configured to reflect the signal quality of the second communication. For example, the value of the second parameter may be positively or negatively related to the signal quality of the second communication. For example, the value of the second parameter is directly related to the signal quality of the second communication. The higher the value of the second parameter, the better the signal quality of the second communication. Alternatively, in a case that the value of the second parameter is negatively related to the signal quality of the second communication, the higher the value of the second parameter, the worse the signal quality of the second communication. In addition, the update operation for the second parameter may be the same as or similar to the update operation for the first parameter, so that the updated second parameter may reflect the signal quality of the second communication. The relevant operation details are not repeated here.

In step S1103, during the period of performing the second communication, the memory management circuit 51 may determine whether the second parameter meets a specific condition (also referred to as the second condition). In response to the second parameter meeting the second condition, in step S1104, the memory management circuit 51 may switch to perform the second communication with the host system 11 based on the connection and the second connection interface standard. However, if the second parameter does not meet the second condition, the memory management circuit 51 may continue to perform the second communication (i.e., step S1104 is not performed).

In an exemplary embodiment, the second parameter is negatively related to the signal quality of the second communication. That is, the less the value of the second parameter, the better the signal quality of the second communication. Therefore, in an exemplary embodiment, the memory management circuit 51 may determine whether the second parameter is less than one threshold value (also referred to as the second threshold value). In response to the second parameter being less than the second threshold value, the memory management circuit 51 may determine that the second parameter meets the second condition. However, in a case that the second parameter is not less than the second threshold value, the memory management circuit 51 may determine that the second parameter does not meet the second condition.

In an exemplary embodiment, the second parameter is positively related to the signal quality of the second communication. That is, the greater the value of the second parameter, the better the signal quality of the first communication. Therefore, in an exemplary embodiment, the memory management circuit 51 may determine whether the second parameter is greater than the second threshold value. In response to the second parameter being greater than the second threshold value, the memory management circuit 51 may determine that the second parameter meets the second condition. However, in a case that the second parameter is not greater than the second threshold value, the memory management circuit 51 may determine that the second parameter does not meet the second condition.

In other words, in the exemplary embodiment of FIG. 11, after switching to perform the second communication with the host system 11 based on the connection and the second connection interface standard, in a case that the signal transfer quality between the memory storage device 10 and the host system 11 is significantly improved (that is, the second parameter meets the second condition), the memory management circuit 51 may switch back to perform the first communication with the host system 11 based on the connection and the first connection interface standard (i.e., perform step S1104).

In an exemplary embodiment, the memory management circuit 51 may record information about the connection interface standard currently used and/or previously used by the connection interface unit 41 (for example, information about the first connection interface standard) in log information. After switching to perform the second communication with the host system 11 based on the connection and the second connection interface standard, in response to the second parameter meeting the second condition, the memory management circuit 51 may switch back to the first communication with the host system 11 based on the connection and the first connection interface standard according to the log information. For example, after switching to perform the second communication with the host system 11 based on the connection and the second connection interface standard, the memory management circuit 51 may obtain the information of the previously used first connection interface standard from the log information. Then, the memory management circuit 51 may switch back to perform the first communication with the host system 11 based on the connection and the first connection interface standard according to this information.

It should be noted that each step in FIG. 8, FIG. 10, and FIG. 11 is described in detail above, and is not repeated here. In addition, each step in FIG. 8, FIG. 10, and FIG. 11 may be implemented as a plurality of program codes or circuits, and the invention is not limited thereto. Moreover, the method of FIG. 8, FIG. 10, and FIG. 11 may be used with the above exemplary embodiments, and may also be used alone, and the invention is not limited thereto.

Based on the above, the device control method, the memory storage device, and the memory control circuit unit provided by the exemplary embodiments of the invention may dynamically switch between different connection interface standards to communicate with the host system (i.e., perform handshake exchange) in a case that at least one data recovery operation between the memory storage device and the host system is successfully performed. For example, after at least one data recovery operation is successfully performed but the signal transfer quality between the memory storage device and the host system is poor, by actively reducing the adopted connection interface standard from Gen 5 of the PCI Express standard to Gen 1 of the PCI Express standard, the power consumption of the memory storage device and/or the host system may be effectively reduced. Later, after the signal transfer quality between the memory storage device and the host system is improved, the performance of the memory storage device and the host system may be improved by actively reverting to previously adopted connection interface standard (such as Gen 5 of the PCI Express standard). In this way, a good balance may be achieved between the energy consumption, performance, and operational stability of the memory storage device.

Although the invention is described with reference to the above embodiments, it is apparent to one of ordinary skill in the art that modifications to the described embodiments may be made without departing from the spirit of the invention. Accordingly, the scope of the invention is defined by the attached claims not by the above detailed descriptions.

What is claimed is:

1. A device control method, configured for a memory storage device, the device control method comprising:
establishing a connection between the memory storage device and a host system;
performing a first communication with the host system based on the connection and a first connection interface standard;
performing a data recovery operation between the memory storage device and the host system via the connection during a period of performing the first communication; and
switching to perform a second communication with the host system based on the connection and a second connection interface standard in a case that the data recovery operation is successfully performed, wherein the first connection interface standard is different from the second connection interface standard.

2. The device control method of claim 1, wherein the step of performing the data recovery operation between the memory storage device and the host system via the connection during the period of performing the first communication comprises:
performing the data recovery operation in response to a signal quality of the first communication being less than a preset condition during the period of performing the first communication.

3. The device control method of claim 2, further comprising:
determining that the signal quality of the first communication is less than the preset condition in response to an error event for the first communication during the period of performing the first communication.

4. The device control method of claim 3, wherein the error event comprises a signal decoding error for the first communication.

5. The device control method of claim 1, wherein the step of switching to perform the second communication with the host system based on the connection and the second connection interface standard in the case that the data recovery operation is successfully performed comprises:
updating a first parameter during the period of performing the first communication, wherein the first parameter reflects a signal quality of the first communication; and
switching to perform the second communication with the host system based on the connection and the second connection interface standard in response to the first parameter meeting a first condition in the case that the data recovery operation is successfully performed.

6. The device control method of claim 5, wherein the step of updating the first parameter during the period of performing the first communication comprises:
updating the first parameter according to a measurement parameter of an eye diagram of a first signal transferred between the memory storage device and the host system during the period of performing the first communication.

7. The device control method of claim 5, wherein the step of updating the first parameter during the period of performing the first communication comprises:
updating the first parameter according to a proportion of a second signal configured to perform a signal verification among all transferred signals between the memory storage device and the host system during the period of performing the first communication.

8. The device control method of claim 5, wherein the step of updating the first parameter during the period of performing the first communication comprises:
updating the first parameter according to a total number of times that the data recovery operation is performed during the period of performing the first communication.

9. The device control method of claim 1, further comprising:
updating a second parameter during a period of performing the second communication, wherein the second parameter reflects a signal quality of the second communication; and
switching back to perform the first communication with the host system based on the connection and the first connection interface standard in response to the second parameter meeting a second condition.

10. The device control method of claim 9, wherein the step of switching back to perform the first communication with the host system based on the connection and the first connection interface standard comprises:
switching back to perform the first communication with the host system based on the connection and the first connection interface standard according to log information,
wherein the log information is configured to record information of the first connection interface standard previously used.

11. The device control method of claim 1, wherein the first connection interface standard and the second connection interface standard are two of a first generation, a second generation, a third generation, a fourth generation, and a fifth generation of a high-speed peripheral component interconnect express standard.

12. The device control method of claim 11, wherein in a case that the first connection interface standard is the fifth generation of the high-speed peripheral component interconnect express standard, the second connection interface standard is one of the first generation, the second generation, the third generation, and the fourth generation of the high-speed peripheral component interconnection express standard,
in a case that the first connection interface standard is the fourth generation of the high-speed peripheral component interconnect express standard, the second connection interface standard is one of the first generation, the second generation, and the third generation of the high-speed peripheral component interconnection express standard,
in a case that the first connection interface standard is the third generation of the high-speed peripheral component interconnect express standard, the second connection interface standard is one of the first generation and the second generation of the high-speed peripheral component interconnect express standard, and
in a case that the first connection interface standard is the second generation of the high-speed peripheral component interconnect express standard, the second connection interface standard is the first generation of the high-speed peripheral component interconnect express standard.

13. The device control method of claim 1, wherein the first communication performed based on the first connection interface standard and the second communication performed based on the second connection interface standard adopt different data transfer standards.

14. A memory storage device, comprising:
a connection interface unit configured to be coupled to a host system;
a rewritable non-volatile memory module; and
a memory control circuit unit coupled to the connection interface unit and the rewritable non-volatile memory module,
wherein the memory control circuit unit is configured to:
establish a connection between the memory storage device and the host system;
perform a first communication with the host system based on the connection and a first connection interface standard;
perform a data recovery operation between the memory storage device and the host system via the connection during a period of performing the first communication; and
switch to perform a second communication with the host system based on the connection and a second connection interface standard in a case that the data recovery operation is successfully performed, wherein the first connection interface standard is different from the second connection interface standard.

15. The memory storage device of claim 14, wherein the operation of the memory control circuit unit performing the data recovery operation between the memory storage device and the host system via the connection during the period of performing the first communication comprises:
performing the data recovery operation in response to a signal quality of the first communication being less than a preset condition during the period of performing the first communication.

16. The memory storage device of claim 15, wherein the memory control circuit unit is further configured to:
determine that the signal quality of the first communication is less than the preset condition in response to an error event for the first communication during the period of performing the first communication.

17. The memory storage device of claim 16, wherein the error event comprises a signal decoding error for the first communication.

18. The memory storage device of claim 14, wherein the operation of the memory control circuit unit switching to perform the second communication with the host system based on the connection and the second connection interface standard in the case that the data recovery operation is successfully performed comprises:
updating a first parameter during the period of performing the first communication, wherein the first parameter reflects a signal quality of the first communication; and
switching to perform the second communication with the host system based on the connection and the second connection interface standard in response to the first parameter meeting a first condition in the case that the data recovery operation is successfully performed.

19. The memory storage device of claim 18, wherein the operation of the memory control circuit unit updating the first parameter during the period of performing the first communication comprises:
updating the first parameter according to a measurement parameter of an eye diagram of a first signal transferred between the memory storage device and the host system during the period of performing the first communication.

20. The memory storage device of claim 18, wherein the operation of the memory control circuit unit updating the first parameter during the period of performing the first communication comprises:
updating the first parameter according to a proportion of a second signal configured to perform a signal verification among all transferred signals between the memory storage device and the host system during the period of performing the first communication.

21. The memory storage device of claim 18, wherein the operation of the memory control circuit unit updating the first parameter during the period of performing the first communication comprises:
updating the first parameter according to a total number of times that the data recovery operation is performed during the period of performing the first communication.

22. The memory storage device of claim 14, wherein the memory control circuit unit is further configured to:
update a second parameter during a period of performing the second communication, wherein the second parameter reflects a signal quality of the second communication; and
switch back to perform the first communication with the host system based on the connection and the first connection interface standard in response to the second parameter meeting a second condition.

23. The memory storage device of claim 22, wherein the operation of the memory control circuit unit switching back to perform the first communication with the host system based on the connection and the first connection interface standard comprises:
switching back to perform the first communication with the host system based on the connection and the first connection interface standard according to log information,
wherein the log information is configured to record information of the first connection interface standard previously used.

24. The memory storage device of claim 14, wherein the first connection interface standard and the second connection interface standard are two of a first generation, a second generation, a third generation, a fourth generation, and a fifth generation of a high-speed peripheral component interconnect express standard.

25. The memory storage device of claim 24, wherein in a case that the first connection interface standard is the fifth generation of the high-speed peripheral component interconnect express standard, the second connection interface standard is one of the first generation, the second generation, the third generation, and the fourth generation of the high-speed peripheral component interconnection express standard,
in a case that the first connection interface standard is the fourth generation of the high-speed peripheral component interconnect express standard, the second connection interface standard is one of the first generation, the second generation, and the third generation of the high-speed peripheral component interconnection express standard,
in a case that the first connection interface standard is the third generation of the high-speed peripheral component interconnect express standard, the second connection interface standard is one of the first generation and the second generation of the high-speed peripheral component interconnect express standard, and
in a case that the first connection interface standard is the second generation of the high-speed peripheral component interconnect express standard, the second connection interface standard is the first generation of the high-speed peripheral component interconnect express standard.

26. The memory storage device of claim 14, wherein the first communication performed based on the first connection interface standard and the second communication performed based on the second connection interface standard adopt different data transfer standards.

27. A memory control circuit unit, configured to control a rewritable non-volatile memory module in a memory storage device, the memory control circuit unit comprising:
a host interface configured to be coupled to a host system;
a memory interface configured to be coupled to the rewritable non-volatile memory module; and
a memory management circuit coupled to the host interface and the memory interface,
wherein the memory management circuit is configured to:
establish a connection between the memory storage device and the host system;
perform a first communication with the host system based on the connection and a first connection interface standard;
perform a data recovery operation between the memory storage device and the host system via the connection during a period of performing the first communication; and
switch to perform a second communication with the host system based on the connection and a second connection interface standard in a case that the data recovery operation is successfully performed, wherein the first connection interface standard is different from the second connection interface standard.

28. The memory control circuit unit of claim 27, wherein the operation of the memory management circuit performing the data recovery operation between the memory storage device and the host system via the connection during the period of performing the first communication comprises:
performing the data recovery operation in response to a signal quality of the first communication being less than a preset condition during the period of performing the first communication.

29. The memory control circuit unit of claim 28, wherein the memory management circuit is further configured to:
determine that the signal quality of the first communication is less than the preset condition in response to an error event for the first communication during the period of performing the first communication.

30. The memory control circuit unit of claim 29, wherein the error event comprises a signal decoding error for the first communication.

31. The memory control circuit unit of claim 27, wherein the operation of the memory management circuit switching to perform the second communication with the host system based on the connection and the second connection interface standard in the case that the data recovery operation is successfully performed comprises:
updating a first parameter during the period of performing the first communication, wherein the first parameter reflects a signal quality of the first communication; and
switching to perform the second communication with the host system based on the connection and the second connection interface standard in response to the first parameter meeting a first condition in a case that the data recovery operation is successfully performed.

32. The memory control circuit unit of claim 31, wherein the operation of the memory management circuit updating the first parameter during the period of performing the first communication comprises:
updating the first parameter according to a measurement parameter of an eye diagram of a first signal transferred between the memory storage device and the host system during the period of performing the first communication.

33. The memory control circuit unit of claim 31, wherein the operation of the memory management circuit updating the first parameter during the period of performing the first communication comprises:
updating the first parameter according to a proportion of a second signal configured to perform a signal verification among all transferred signals between the memory storage device and the host system during the period of performing the first communication.

34. The memory control circuit unit of claim 31, wherein the operation of the memory management circuit updating the first parameter during the period of performing the first communication comprises:
updating the first parameter according to a total number of times that the data recovery operation is performed during the period of performing the first communication.

35. The memory control circuit unit of claim 27, wherein the memory management circuit is further configured to:
update a second parameter during a period of performing the second communication, wherein the second parameter reflects a signal quality of the second communication; and
switch back to perform the first communication with the host system based on the connection and the first connection interface standard in response to the second parameter meeting a second condition.

36. The memory control circuit unit of claim 35, wherein the operation of the memory management circuit switching back to perform the first communication with the host system based on the connection and the first connection interface standard comprises:
switching back to perform the first communication with the host system based on the connection and the first connection interface standard according to log information,
wherein the log information is configured to record information of the first connection interface standard previously used.

37. The memory control circuit unit of claim 27, wherein the first connection interface standard and the second connection interface standard are two of a first generation, a second generation, a third generation, a fourth generation, and a fifth generation of a high-speed peripheral component interconnect express standard.

38. The memory control circuit unit of claim 37, wherein in a case that the first connection interface standard is the fifth generation of the high-speed peripheral component interconnect express standard, the second connection interface standard is one of the first generation, the second generation, the third generation, and the fourth generation of the high-speed peripheral component interconnection express standard,
in a case that the first connection interface standard is the fourth generation of the high-speed peripheral component interconnect express standard, the second connection interface standard is one of the first generation, the second generation, and the third generation of the high-speed peripheral component interconnection express standard,
in a case that the first connection interface standard is the third generation of the high-speed peripheral component interconnect express standard, the second connection interface standard is one of the first generation and the second generation of the high-speed peripheral component interconnect express standard, and
in a case that the first connection interface standard is the second generation of the high-speed peripheral component interconnect express standard, the second connection interface standard is the first generation of the high-speed peripheral component interconnect express standard.

39. The memory control circuit unit of claim 27, wherein the first communication performed based on the first connection interface standard and the second communication performed based on the second connection interface standard adopt different data transfer standards.
